(19) United States
(12) Patent Application Publication
(10) Pub. No.: US 2012/0257130 A1
(43) Pub. Date: Oct. 11, 2012

(54) Tunable Wavelength Filter

(75) Inventors: Edwin Jan Klein, Enschede (NL); Rene Gerrit Heideman, Oldenzaal (NL)

(73) Assignee: OCTROLIX BV, Enschede (NL)

(21) Appl. No.: 13/081,913

(22) Filed: Apr. 7, 2011

(51) Int. Cl. G02F 1/1335; G02B 5/28

(52) U.S. Cl. 349/18; 359/578

(57) ABSTRACT

A wavelength filter based on a symmetric PLC circuit comprising an MZ filter-based demultiplexer, a waveguide resonator, and an MZ filter-based multiplexer is presented. The wavelength filter is tuned using pulse width modulated drive signals that enable fine wavelength control resolution. Embodiments in accordance with the present invention attain narrow spectral filtering capability over a wide wavelength tuning range. Further, embodiments in accordance with the present invention mitigate chromatic dispersion.

### CROSS-REFERENCE TO RELATED APPLICATIONS

moon The underlying concepts, but not necessarily the language, of U.S. Pat. No. 7,146,087, issued Dec. 5, 2006 (Attorney Docket: 145-001US), is incorporated herein by reference. If there are any contradictions or inconsistencies in language between this application and the case that has been incorporated by reference that might affect the interpretation of the claims in this case, the claims in this case should be interpreted to be consistent with the language of this case.

### FIELD OF THE INVENTION

The present invention relates to planar lightwave circuits in general, and, more particularly, to planar-lightwave-circuit-based tunable wavelength filters.

### BACKGROUND OF THE INVENTION

Wavelength filters play a prominent role in many application areas, including optical telecommunications, optical spectroscopy, cryptography, and homeland defense. A wavelength filter is an element that removes a portion of the wavelength spectrum of an optical signal that is provided at a first output port. In some applications, it is also desirable to be able to tune the filter response of a wavelength filter across at least a portion of the wavelength spectrum of the optical signal. In some cases, it is desirable that the removed portion be redirected to a second output port.

In recent years, a type of wavelength filter referred to as a Tunable Optical Add-Drop Filter (TOADF) has been of particular interest for use in optical telecommunications networks. Current wavelength division multiplexed (WDM) networks typically operate with 40 to 80 wavelength channels, which are separated from one another by only a few nanometers (nm). A TOADF enables an individual wavelength channel of a WDM system to be redirected from one destination to another destination without perturbing the rest of the wavelength channels in the system. This enables wavelength agility in WDM networks that enables more efficient utilization of network resources, rapid reconfiguration to accommodate temporary periods of high bandwidth demand, and reduced operations expenses.

Many technologies have been considered for the development of a TOADF. Micro-Electro-Mechanical free-space switches have been used, for example, to redirect optical signals travelling through a free-space region. Unfortunately, these systems tend to be very expensive to produce, difficult to implement, and complicated to operate.

Other approaches have been considered wherein guided-wave switch networks are integrated with surface waveguides. One such approach utilizes an Array-Waveguide-Grating (AWG) to distribute the individual wavelength channels of a WDM signal into separate waveguides. Surface-waveguide switches are then employed to redirect one or more of the wavelength channels to alternate output ports coupled to these waveguides. Unfortunately, such an approach requires a large number of switches (at least as many as wavelength channels). In addition, an AWG must be carefully designed for the specific bandwidths of the individual wavelength channels. Further, AWGs are large devices that require considerable chip real estates. As a result, AWG-based systems tend to be extremely expensive.

Another surface-waveguide-based prior-art approach relies upon a network of Mach-Zehnder Interferometers (MZIs). Unfortunately, such systems also tend to be quite large and expensive. Further, such systems are exceptionally sensitive to variations in fabrication due to the large number of MZI's required.

Yet another surface-waveguide-based prior-art approach utilizes a cascade of tunable microring resonators. This approach has an advantage in that the resulting devices are relatively small. In addition, good filter functionality can be accomplished with relatively few tuning elements. Unfortunately, microring resonator functionality is based on its resonance. As a result, different wavelengths travel at markedly different speeds through the network. This is referred to as chromatic dispersion, and it develops rapidly and reaches an unacceptable level after only a few passes through microring resonators. The range of wavelengths over which the microring resonators are operable (i.e., their free spectral range) is limited as a result.

For most wavelength filter applications, especially TOADF applications, it is desirable that the filters have, not only a narrow filter response, but also that they are tunable over a wide wavelength range. Unfortunately, these attributes are difficult, if not impossible, to provide using prior-art technologies.

### SUMMARY OF THE INVENTION

The present invention provides a new surface-waveguide-based wavelength filter that is based on a combination of Mach-Zehnder filters and a waveguide resonator. The wavelength filter is formed in planar-lightwave-circuit technology and includes a balanced Mach-Zehnder interferometer having a waveguide resonator at its center. By virtue of its balanced nature, the wavelength filter mitigates chromatic dispersion and enables a compact circuit layout. Embodiments of the present invention are particularly well suited for use in tunable optical add-drop filters, spectrometers, and multi-casting communications applications.

Wavelength filters in accordance with the present invention comprise a wavelength demultiplexer that includes one or more Mach-Zehnder filters (MZ filters), a waveguide resonator, and a wavelength multiplexer that includes one or more MZ filters. The wavelength demultiplexer, waveguide resonator, and wavelength multiplexer are arranged substantially symmetrically about a line of symmetry through the waveguide resonator.

The wavelength filter receives an input signal having a range of wavelengths at an input port, selectively removes a narrow wavelength channel from the input signal and provides it to the drop port as a drop signal, while conveying the remainder of the input signal to an output port as a through signal. The drop signal is coupled to the drop port through the combination of the wavelength demultiplexer and waveguide resonator. In some embodiments, an add port is included for injecting a new signal into the pass signal via the waveguide resonator and wavelength multiplexer.

Embodiments of the present invention derive advantage over prior-art waveguide-based wavelength filters by exploiting a combination of the strengths of MZ filters and waveguide resonators. Specifically, the present invention takes advantage the fact that MZ filters having large free-spectral range can be readily fabricated. Unfortunately, such MZ filters are characterized by a wide spectral response. Waveguide resonators, however, can have a narrow filter response. By coupling an MZ filter and a waveguide resonator, therefore, their combined spectral response can be limited to a very narrow width while maintaining a large free-spectral range.

In some embodiments, the planar lightwave circuit elements are formed in a high-index-contrast, composite-core waveguide technology that enables waveguide filter designs having functionality at wavelengths as short as 400 nm to as long as 2350 nm.

An illustrative embodiment of the present invention comprises a TOADF having an input port, a through port, a drop port, and an add port. The TOADF includes a wavelength demultiplexer based on a first pair of MZ lattice filters, a waveguide resonator, and a wavelength multiplexer based on a second pair of MZ lattice filters. The wavelength demultiplexer and wavelength multiplexer are substantially matched such that they have substantially identical performance characteristics. Further, each of the wavelength demultiplexer, waveguide resonator, and wavelength multiplexer are thermally tunable such that their individual filter responses can be controlled and so that the TOADF can be tuned across a range of wavelengths. In some embodiments, at least one of the wavelength demultiplexer, waveguide resonator, and wavelength multiplexer are tunable via a region of liquid crystal material that is optically coupled with it.

In operation, the TOADF receives an input signal characterized by a range of wavelengths at the input port. At the wavelength demultiplexer, the MZ filters couple a wavelength channel of the input signal to the waveguide resonator and pass the remaining wavelengths of the input signal to the through port. The waveguide resonator acts as a filter that further narrows the spectral width of the dropped channel and couples this narrowed signal to a bus waveguide that conveys it to the drop port of the TOADF. The bus waveguide is also optically coupled with an add port at which another signal (at the same wavelength as that of the dropped signal) can be injected into the optical signal received at the through port. This added signal is coupled to the through port through the waveguide resonator and the wavelength multiplexer.

Each of the input port and output port is optically coupled with a wavelength filter section through an optical switch. These optical switches enable substantially hitless operation of the TOADF. Further, these optical switches enable a controllable amount of the input signal to be dropped, which facilitates the use of the TOADF in multi-casting communications applications.

In the illustrative embodiment, the heaters thermally coupled with each of the wavelength demultiplexer, waveguide resonator, and wavelength multiplexer are controlled via closed-loop, pulse-width modulation (PWM) control. A controller receives a temperature signal from the TOADF chip and controls the duty factor of a high-frequency signal used to drive each heater. This control methodology enables a compact electrical driver that is capable of fine resolution control over the functionality of the TOADF over a wide range of temperatures. Further, PWM control enables simple detection of heater failure. Still further, the use of PWM control of the heaters reduces the power consumption as compared to analog heater control such as is used in the prior art.

An embodiment of the present invention includes a wavelength filter comprising: a wavelength demultiplexer comprising first vernier filter comprising a first lattice filter that is a Mach-Zehnder filter and a second lattice filter that is a Mach-Zehnder filter; a waveguide resonator; and a wavelength multiplexer comprising a second vernier filter comprising a third lattice filter that is a Mach-Zehnder filter and a fourth lattice filter that is a Mach-Zehnder filter; wherein the wavelength demultiplexer, the waveguide resonator, and the wavelength multiplexer collectively define a planar lightwave circuit that is substantially symmetric about a line of symmetry through the waveguide resonator, and wherein the planar lightwave circuit is wavelength tunable over a wavelength range.

### BRIEF DESCRIPTION OF THE DRAWINGS

FIG. 1 depicts a schematic diagram of a tunable add-drop filter module in accordance with an illustrative embodiment of the present invention.

FIG. 2 depicts a perspective view of a portion of a “box-type” composite-core waveguide that includes the preferred waveguide-materials system.

FIGS. 3A and 3B depict a schematic drawing of a wavelength filter and a top view of a circuit layout of a wavelength filter, respectively, in accordance with the illustrative embodiment of the present invention.

FIG. 4 depicts operations of a method for filtering a wavelength channel from a WDM signal in accordance with the illustrative embodiment of the present invention.

FIG. 5 depicts a schematic drawing of a top view of a circuit layout for a wavelength demultiplexer in accordance with the illustrative embodiment of the present invention.

FIG. 6 depicts the spectral responses of the individual lattice filters of wavelength demultiplexer 318.

FIG. 7 depicts a schematic drawing of a top view of a circuit layout for a waveguide resonator in accordance with the illustrative embodiment of the present invention.

FIG. 8 depicts a plot of the spectral responses of a wavelength demultiplexer and waveguide resonator in accordance with the illustrative embodiment of the present invention.

FIG. 9 depicts plots of the optical power passed and dropped by a wavelength filter in accordance with the illustrative embodiment of the present invention.

FIG. 10 depicts a schematic drawing of a top view of a circuit layout for a wavelength multiplexer in accordance with the illustrative embodiment of the present invention.

### DETAILED DESCRIPTION

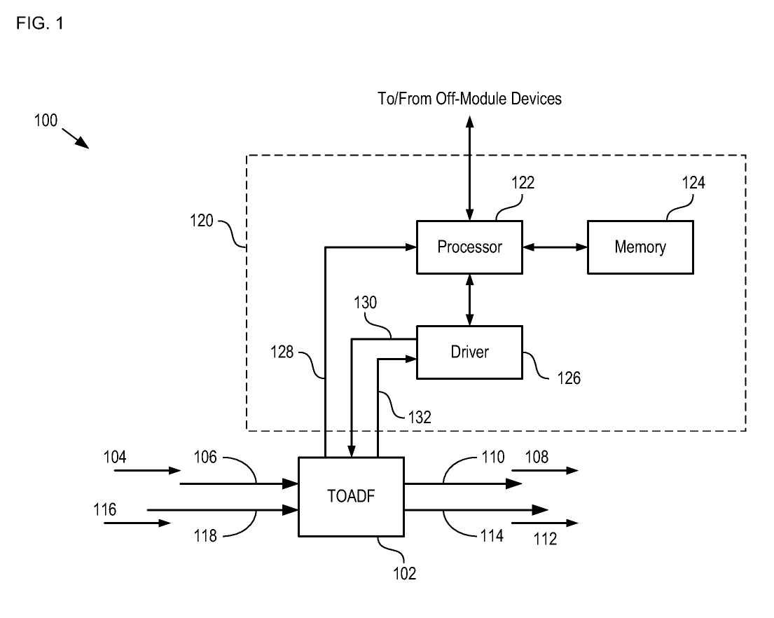

FIG. 1 depicts a schematic diagram of a tunable add-drop filter module in accordance with an illustrative embodiment of the present invention. Module 100 comprises TOADF 102, waveguides 106, 110, 114, and 118, and controller 120.

TOADF 102 is a photonic lightwave circuit (PLC) that is capable of reconfiguring the wavelength channels in a WDM communications system. TOADF 102 comprises high-contrast surface waveguides that are characterized by a composite guiding region. The composite guiding region comprises an inner core of stoichiometric silicon oxide (SiO₂) and an outer core of stoichiometric silicon nitride (Si₃N₄) and a cladding region of silicon dioxide. Although this “composite-core” waveguide structure is the preferred waveguide structure, TOADF 102 can comprise surface waveguides formed in any waveguide structure or materials system.

The use of a high-contrast waveguide structure enables embodiments of the present invention to exhibit low propagation loss yet strong optical mode confinement. High-contrast waveguides are characterized by a large difference between the refractive indices of the core and cladding, respectively (typically, at least 5%). High-contrast waveguides enable tight optical mode confinement, which in turn enables waveguide resonators in accordance with the present invention to have small diameter and large free spectral range. Further, composite-core high-contrast waveguides, in particular, can be designed for operation over wavelength ranges located anywhere within the range of approximately 400 nm to approximately 2350 nm. Suitable composite-core waveguide technologies are described in detail in “Low Modal Birefringent Waveguides and Method of Fabrication,” U.S. Pat. No. 7,146,087, issued Dec. 5, 2006, which is incorporated by reference herein.

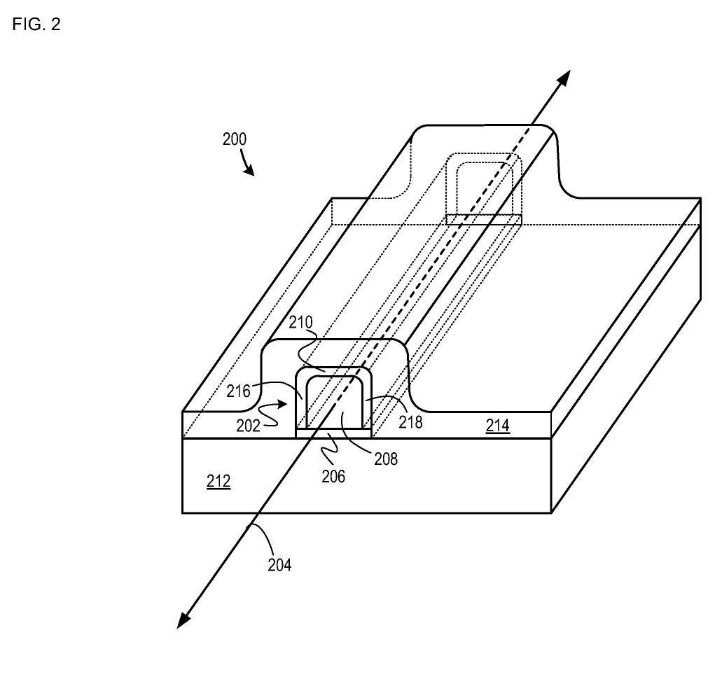

FIG. 2 depicts a perspective view of a portion of a “box-type” composite-core waveguide that includes the preferred waveguide-materials system. Waveguide 200 has an axis of signal propagation 204. The box waveguide comprises composite guiding region 202, which is surrounded by lower cladding layer 212 and upper cladding layer 214. The material(s) that compose the lower cladding layer and the upper cladding layer have a refractive index that is lower than the materials that compose composite guiding region 202. By virtue of this difference in refractive indices, the lower and upper cladding layers serve to confine propagating light to composite guiding region 202.

As depicted in FIG. 2, composite guiding region 202 comprises layers 206, 208, and 210. Layers 206 and 210 sandwich interposed layer 208. Layer 210 is a conformal layer that is disposed on layer 208 such that layer 210 forms sidewalls 216 and 218. Composite guiding region 202 is itself sandwiched by lower cladding layer 212 and upper cladding layer 214.

Composite guiding region 202 can also be described as including an inner core (i.e., layer 208) and an outer core, wherein the outer core includes a lower portion (i.e., layer 206), sidewalls (i.e., sidewalls 216 and 218), and an upper portion (i.e., layer 210). In some embodiments, at least two of layers 206 and 210 and sidewalls 216 and 218 have thicknesses that are different form one another. In some embodiments, composite guiding region comprises only a lower region (e.g., layer 206), an interposed layer (e.g., layer 208), and an upper portion (e.g., the portion of layer 210 that resides on top of layer 208).

Waveguide 200 can be formed as follows. First, a lower cladding layer (e.g., lower cladding layer 212 in FIG. 2) is formed. The lower cladding layer (in conjunction with the upper cladding layer) confines a propagating optical signal within the composite guiding region. In some embodiments, the lower cladding layer comprises silicon dioxide. A more extensive list of suitable materials is provided later in this specification.

The lower portion of the outer core (e.g., layer 206) is deposited or grown on the lower cladding layer. This operation forms the bottom layer of composite guiding region 202. In some embodiments, after the lower portion of the outer core is deposited/grown, it is suitably patterned.

The material that forms the inner core (e.g., layer 208) is deposited or grown on the lower portion of the outer core. After deposition/growth, the material is appropriately patterned (e.g., for forming a stripe or ridge waveguide, etc.).

The outer core is completed with the deposition or growth of the side/upper portion of the outer core (e.g., layer 210). This material is appropriately patterned. The upper portion of the outer core advantageously conforms to the underlying topography of the lower portion of the outer core and the patterned inner core.

An upper cladding layer (e.g., layer 214) is deposited or grown on the upper portion of the outer core.

By removing the “side” portions of outer core 210 of box waveguide 200, a (double) stripe waveguide (not depicted) having an inner core and an outer core is formed.

Regarding materials selection, in some embodiments, stoichiometric materials are used to form composite guiding region 202. In some embodiments, layer 208 comprises silicon dioxide (preferably stoichiometric) deposited by tetraethylorthosilicate (TEOS) and layers 206 and 210 comprise silicon nitride (preferably stoichiometric). See, U.S. Pat. No. 7,146,087.

A more extensive list of materials that are suitable for use as the upper and lower cladding layers as well as the layers of the composite guiding region includes, but is not limited to, stoichiometric silicon nitride, silicon dioxide, silicon, polysilicon, silicon carbide, silicon monoxide, silicon-rich silicon nitride, indium phosphide, gallium arsenide, indium-gallium arsenide, indium-gallium arsenide-phosphide, lithium niobate, silicon oxy-nitride, phosphosilicate glass, and borophosphosilicate glass. In addition, compounds such as silicon nitride are effectively different materials with different material properties when their composition is other than stoichiometric, and these different material compounds can be used in combination in similar fashion to those listed above.

Returning now to FIG. 1, TOADF 102 receives WDM signal 104 on input waveguide 106 and provides WDM signal 108 on output waveguide 110. WDM signal comprises a plurality of wavelength channels having wavelengths across the wavelength range from 1530 nm to 1565 nm (i.e., the optical telecommunications “C-band”). TOADF 102 is designed for operation across the wavelength range of the C-band. In some embodiments, TOADF 102 is operable over a different wavelength range.

TOADF 102 can be configured to simply pass WDM signal 104 (substantially unperturbed) from input waveguide 106 to output waveguide 110 as WDM signal 108, or remove a controllable portion of one of the wavelength channels of WDM signal 104 from input waveguide 106 and couple it to drop waveguide 114 as drop signal 112. The portion of the dropped wavelength channel that is dropped to drop waveguide 114 can be controlled within the range of zero percent to 100 percent. TOADF 102 can be further configured to add a wavelength channel (wavelength signal 116), received on add waveguide 118, to WDM signal 108.

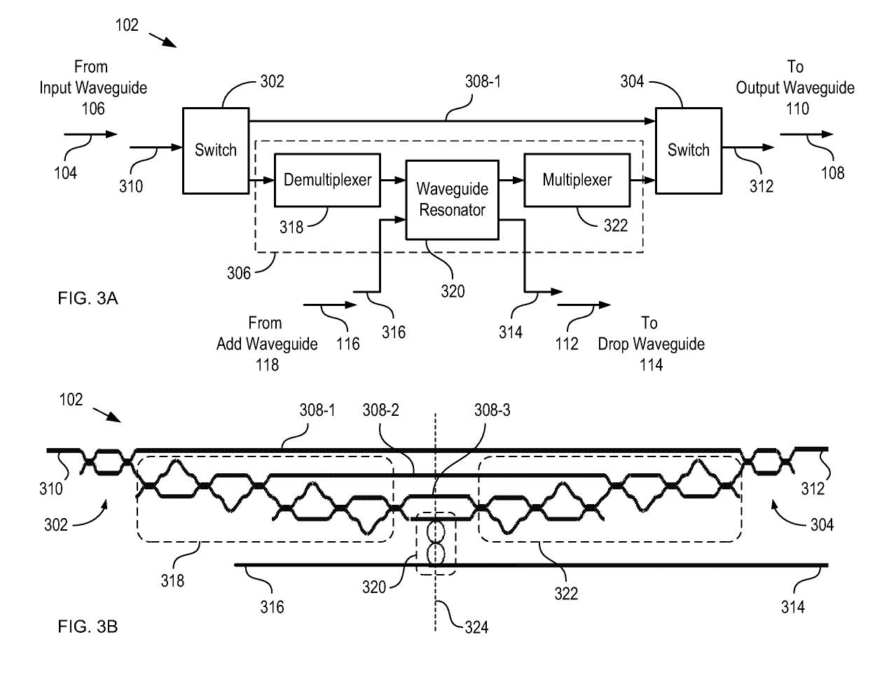

It is an aspect of the present invention that TOADF 102 has a filter performance that enables it to selectively drop any one wavelength channel from WDM signal 104 to drop waveguide 114 without significantly affecting the other wavelength channels of WDM signal 108—even in dense wavelength-division multiplexing (DWDM) applications. As a result, TOADF 102 requires filter performance that is spectrally narrow, but must be tunable across an operating wavelength range that is large enough to cover the entire 35 nm-wide C band. It is also highly desirable that a wavelength filter exhibits low chromatic dispersion and a flat passband (i.e, the non-dropped channels pass through the filter relatively unperturbed). To date, it has been difficult, if not impossible, to satisfy these competing requirements using prior-art waveguide-based wavelength filters. TOADF 102 is described in more detail below and with respect to FIGS. 3 through 10.

It should be noted that, although in the illustrative embodiment WDM signal 104 comprises discrete wavelength channels, the present invention enables the removal of a narrow wavelength portion from a WDM signal that is substantially continuous along a wavelength range. In other words, some embodiments of the present invention can operate as a wavelength “notch” filter.

Controller 120 is a system for controlling the functionality of TOADF 102. Controller 120 determines: whether TOADF 102 drops a wavelength channel from WDM signal 104 to drop waveguide 114; which wavelength channel of WDM signal 104 is coupled to drop waveguide 114; the fraction of the selected dropped wavelength channel coupled to drop waveguide 114; and whether TOADF 102 enables the addition of add signal 116 to WDM signal 108.

Controller 120 comprises processor 122, memory 124, and driver 126. In some embodiments, processor 122, memory 124, and driver 126 are integrated into a single chip or multi-chip module.

Processor 122 is a conventional microprocessor that monitors the temperature of TOADF 102 via signal 128, controls driver 126 to tune the wavelength response and functionality of TOADF 102, stores and retrieves data (e.g., calibration information, look-up table entries, etc.) to and from memory 122, and communicates with off-module electronics. Memory 124 is a conventional memory module, such as an Electrically Erasable Programmable Read-Only Memory (EEPROM), random-access memory, read-only memory, etc.

Driver 126 is a high frequency, pulse-width modulation (PWM) controller that provides PWM signals to heater elements included in TOADF 102. Driver 126 provides each heater element with an average value of power by rapidly turning the current to the heater element on and off. By controlling the duty factor (i.e., the fraction of the switching interval that the power is provided), the power level provided to the heater element is controlled. It will be clear to one skilled in the art, after reading this specification, how to specify, make, and use driver 126.

The use of PWM to control the temperature of the heater elements affords embodiments of the present invention several advantages over tunable wavelength filters in the prior art, such as:
i. high-resolution temperature control; or
ii. compact digital drive circuit implementations; or
iii. detection of heater element failure; or
iv. high output current capability; or
v. reduced power consumption over analog control signals; or
vi. any combination of i, ii, iii, iv and v.

One skilled in the art will recognize that an analog control system for controlling a heater element, such as heater control systems of the prior art, dissipates some amount of power at all times. This constant power dissipation arises from the fact that the output of an analog temperature controller is always between a minimum and maximum value and current always flows through the resistance of the heater element.

In contrast, a PWM heater control system in accordance with the present invention toggles between full on and full off. On average, therefore, a PWM controller in accordance with the present invention dissipates less power that analog heater control systems of the prior art.

Processor 122, memory 124, driver 126, and TOADF 102 collectively define a feedback loop wherein processor 122 controls heaters included in TOADF 102 by controlling the output of driver 126 based on temperature signal 128 received from TOADF 102 and data stored in memory 124. The use of such a feedback loop enables functionality control over a range of operating temperatures.

In some embodiments, TOADF 102 is tuned via regions of liquid-crystal material that are optically coupled to the PLC and driver 102 is a conventional liquid-crystal controller. In some embodiments, driver 102 is other than a PWM controller.

In some embodiments, controller 120 includes communications capability for handling off-module communication of module 100.

FIGS. 3A and 3B depict a schematic drawing of a wavelength filter and a top view of a circuit layout of a wavelength filter, respectively, in accordance with the illustrative embodiment of the present invention. TOADF 102 comprises switches 302 and 304, filter section 306, bypass waveguides 308-1, 308-2, and 308-3, input-port 310, through-port 312, drop-port 314, and add-port 316.

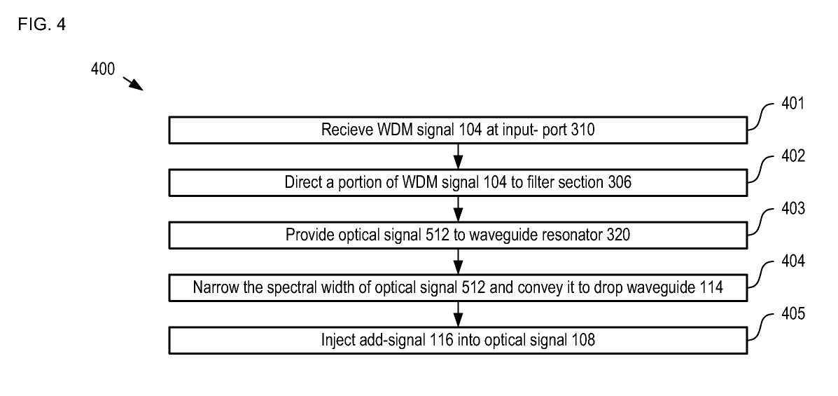

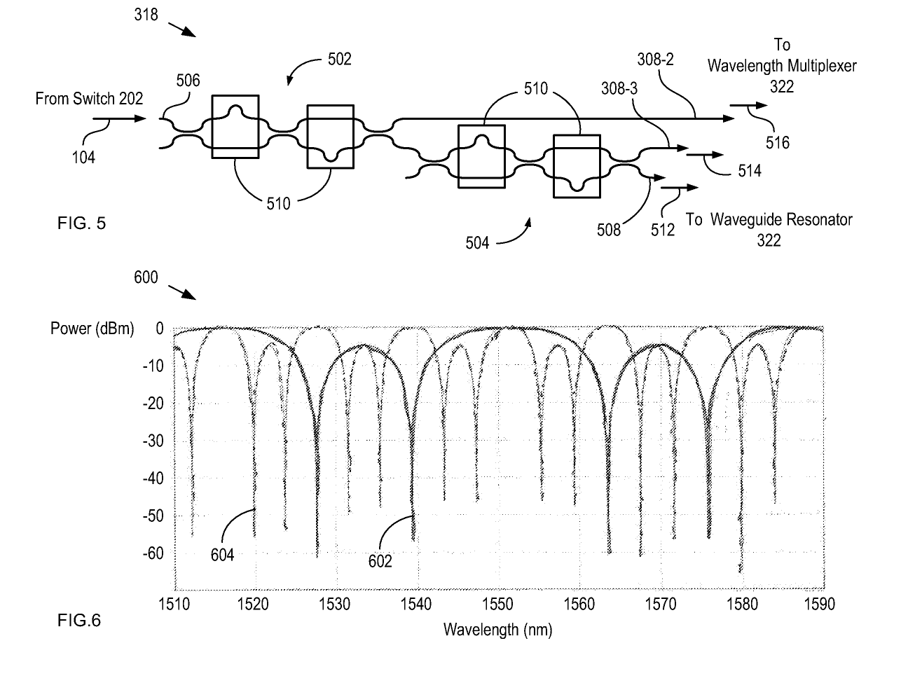

FIG. 4 depicts operations of a method for filtering a wavelength channel from a WDM signal in accordance with the illustrative embodiment of the present invention. Method 400 is described with continuing reference to FIGS. 1, 3A, and 3B, with added reference to FIGS. 5-10. Method 400 begins with operation 401, wherein WDM signal 104 is received at input-port 310 of TOADF 102.

Input-port 310 is the input port of switch 302. Input-port 310 is optically coupled with input waveguide 106. Each of switches 302 and 304 is a tunable waveguide-coupler. Switches 302 and 304 are thermally tuned to distribute the optical energy received at input-port 310 between each of filter section 306 and bypass waveguide 308-1. In some embodiments, at least one of switches 302 and 304 is tuned acousto-optically. It will be clear to one skilled in the art, after reading this specification, how to specify, make, and use switches 302 and 304. In some embodiments, at least one of switches 302 and 304 is tuned via controlling the phase of liquid crystal material optically coupled with the waveguides of the switch.

Switches 302 and 304 enable any portion of the optical power of WDM signal 104 (from substantially zero percent to substantially 100 percent) to be switched between bypass waveguide 308-1 and filter section 306. Switches 302 and 304 enable TOADF 102 to operate in substantially “hitless” fashion. They also facilitate the use of TOADF 102 is multi-casting applications where more than one user shares the same wavelength channel.

At operation 402, WDM signal 104 is directed to filter section 306.

Filter section 306 comprises wavelength demultiplexer 318, waveguide resonator 320, and wavelength multiplexer 322. Filter section 306 collectively couples one wavelength channel of WDM signal 104 to drop-port 314 as drop signal 112. Drop-port 314 is optically coupled with drop waveguide 114.

Wavelength demultiplexer 318, waveguide resonator 320, and wavelength multiplexer 322 are arranged in a layout that is substantially symmetric about line 324. Filter section 306, therefore, forms a universal balanced interferometer that mitigates the effects of chromatic dispersion.

### Principle of Filter Operation

Filter section 306 combines the strengths of Mach-Zehnder-based filters with the strengths of waveguide resonator-based filters. One skilled in the art will recognize that MZ filters having a large free spectral range can be readily fabricated. Unfortunately, MZ filters do not have a narrow spectral response. On the other hand, a waveguide resonator having a narrow filter response can be readily fabricated, but waveguide resonators are characterized by limited maximum free spectral range because of the small refractive index contrast of conventional waveguide technology.

Wavelength demultiplexer 318 receives WDM signal 104 and provides a portion of it to waveguide resonator 320. Wavelength demultiplexer 318 includes one or more MZ filters that collectively define a wavelength blocker that, in principle, blocks all but one wavelength channel of WDM signal 104 from reaching waveguide resonator 320. Because of the wide spectral responses of its MZ filters, however, wavelength demultiplexer 318 typically passes the unblocked wavelength channel to waveguide resonator 320 as well as significant optical power from neighboring wavelength channels.

Waveguide resonator 320 is resonant for a comb of narrow wavelength channels, separated from one another by the free-spectral range of the waveguide resonator. Only light characterized by the wavelength of these combs can “pass” through the waveguide resonator. The waveguide resonator blocks light characterized by other wavelengths. Waveguide resonator 320 is tuned so that it is resonant at the wavelength channels of wavelength demultiplexer 318.

Waveguide resonator 320 receives the optical power passed to it by wavelength demultiplexer 318, but blocks optical power at wavelengths other than a resonant wavelength. As a result, waveguide resonator 320 passes only one narrow wavelength channel of WDM signal 104 to drop-port 314.

At operation 403, wavelength demultiplexer 318 receives WDM signal 104.

FIG. 5 depicts a schematic drawing of a top view of a circuit layout for a wavelength demultiplexer in accordance with the illustrative embodiment of the present invention. Wavelength demultiplexer 318 comprises MZ filters 502 and 504, input-port 506, output-port 508, and control elements 510.

Wavelength demultiplexer 318 receives WDM signal 104 at input-port 506 and couples optical signal 512 to waveguide resonator 320 at output-port 508. Input-port 506 is optically coupled to input-port 310 through switch 302. The wavelength range included in optical signal 512 is based on the tuned spectral response of wavelength demultiplexer 318, which, in turn, depends on the temperatures of heaters 510. The temperature of heaters 510 are controlled by drive signals received from PWM driver 126, as described above and with respect to FIG. 3. Bypass waveguides 308-2 and 308-3 convey signals 514 and 516, respectively, which contain the optical energy of WDM signal 104 not coupled to waveguide resonator 320, to wavelength multiplexer 322.

Wavelength demultiplexer 318 is a two-stage, cascaded lattice filter, wherein each lattice filter comprises a waveguide-based MZ filter. The cascaded lattice filters collectively define a vernier filter having a wavelength range of approximately 36 nm. As a result, wavelength demultiplexer 318 is operable over the entire C-band. In some embodiments, wavelength demultiplexer 318 comprises a single MZ filter-based lattice filter. In some embodiments, wavelength demultiplexer 318 is a multi-stage, cascaded MZ filter-based lattice filter that comprises more than two MZ filters.

Wavelength demultiplexer 318 is referred to as a “vernier filter.” It operates in analogous fashion to a vernier scale readout, in that wavelength demultiplexer 318 can pass to output-port 508 only those wavelength channels located where the filter responses of both of lattice filters 502 and 504 are aligned. All other wavelength channels are blocked by wavelength demultiplexer 318 from output-port 508 and are, instead, provided to bypass waveguides 308-2 and 308-3. Lattice filter 502 is an MZ filter that is designed to block the passage of two out of three wavelength channels that are spaced at approximately 12 nm. Lattice filter 504 is an MZ filter that is designed to block two out of three wavelength channels that are spaced at approximately 4 nm. As a result, the lattice filters of wavelength demultiplexer 318 collectively block eight of nine wavelength channels, spaced at approximately 4 nm, over a free spectral range of approximately 36 nm.

Each of MZ filters 502 and 504 is thermally coupled with a control element 510, which controls the filter response of the MZ filter. Each of control elements 510 is a conventional thin-film heater disposed on the waveguides that compose the MZ filters. The temperature of each of control elements 510 is controlled by PWM drive signals provided by driver 126, as discussed above and with respect to FIG. 1 (not shown in FIG. 5 for clarity).

In some embodiments, control elements 510 are regions of liquid crystal material that is optically coupled with the waveguides that compose the MZ filters. In such embodiments, the optical state of control elements 510 are controlled via conventional liquid crystal control signals.

One skilled in the art will recognize that the design of each of MZ filters 502 and 504 is based on wavelength demultiplexer operation for an exemplary wavelength channel spacing within the C-band. In some embodiments, at least one of MZ filters 502 and 504 is designed with at least one of a different filter response, different channel spacing (e.g., 100 GHz, 50 GHz, 25 GHz, etc.), and a different wavelength range. In embodiments wherein MZ filters comprise composite-core waveguides, the wavelength demultiplexer 318 can be designed for operation within any wavelength range from approximately 400 nm to approximately 2350 nm.

FIG. 6 depicts the spectral responses of the individual lattice filters of wavelength demultiplexer 318. Plot 600 includes the spectral responses of lattice filter 502 (i.e., trace 602) and lattice filter 504 (i.e., trace 604), as seen at output-port 508, in response to input light having a continuous spectral width from 1510 nm to 1590 nm.

Trace 602 shows that the filter response of lattice filter 502, individually, couples only wavelengths located around 1515 nm, 1551 nm, and 1589 nm to output-port 508.

In similar fashion, trace 604 shows that the filter response of lattice filter 504, individually, couples only wavelengths located around 1515 nm, 1527 nm, 1539 nm, 1551 nm, 1563 nm, 1575 nm, and 1589 nm to output-port 508.

The cascaded combination of lattice filters 502 and 504 is characterized by a collective filter response defined by the combination of their individual spectral responses. In other words, wavelength demultiplexer 318 couples only wavelengths located around 1515 nm, 1551 nm, and 1589 nm to output-port 508.

At operation 404, waveguide resonator 320 narrows the spectral width of optical signal 512 and couples it to drop-port 314 as drop signal 112.

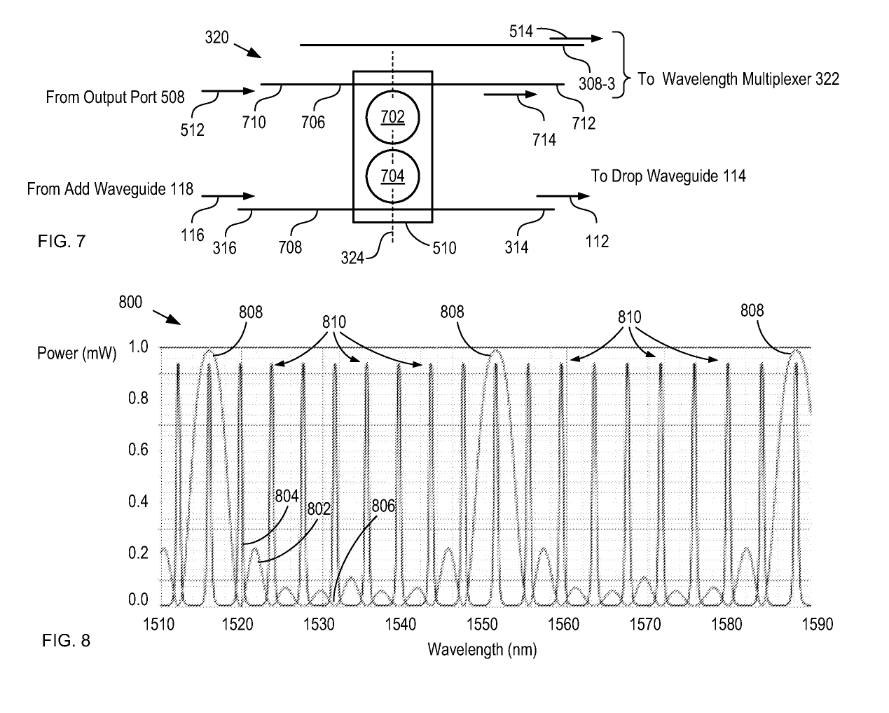

FIG. 7 depicts a schematic drawing of a top view of a circuit layout for a waveguide resonator in accordance with the illustrative embodiment of the present invention. Waveguide resonator 320 comprises rings 702 and 704, bus waveguides 706 and 708, input port 710, pass-port 712, drop-port 314, add-port 316, and control element 510.

Each of rings 702 and 704 is a waveguide ring having a diameter capable of exhibiting resonance at any wavelength within the C-band.

Each of bus waveguides 706 and 708 is a substantially straight waveguide portion suitable for conveying light having any wavelength within the C-band.

Bus waveguide 706 is optically coupled to ring 702, bus waveguide 708 is optically coupled to ring 704, and ring 702 is optically coupled with ring 704. As a result, ring 702, ring 704, bus waveguide 706, and bus waveguide 708 collectively define a series-coupled, double-ring resonator having a free spectral range of approximately 4 nm. The resonant wavelengths of waveguide resonator 320 are thermally tuned via control element 510. Waveguide resonator 320 has a plurality of resonant wavelengths, spectrally separated by its free spectral range. Waveguide resonator 320 couples wavelengths of optical signal 512 at which waveguide resonator 320 is resonant to bus waveguide 706. These wavelengths compose drop signal 112. Bus waveguide 706 includes drop-port 314, which is optically coupled with drop waveguide 114. The optical energy of optical signal 512 that is not coupled to bus waveguide 706 is conveyed to pass-port 712 as optical signal 714.

In some embodiments, waveguide resonator 320 comprises one ring 702. In some embodiments, waveguide resonator 320 comprises more than two rings. In some embodiments, waveguide resonator 320 comprises at least one racetrack structure.

FIG. 8 depicts a plot of the spectral responses of a wavelength demultiplexer and waveguide resonator in accordance with the illustrative embodiment of the present invention. Plot 800 shows the spectral responses of wavelength demultiplexer 318 (trace 802) and waveguide resonator 320 (trace 804), as seen at drop-port 314, in response to input light having a continuous spectral width from 1510 nm to 1590 nm.

Trace 802 comprises a series of nulls 806, which are separated by approximately 4 nm. Nulls 806 are located at the wavelengths of the wavelength channels of WDM signal 104 not coupled to waveguide resonator 320 by wavelength demultiplexer 318. Trace 802 exhibits three nodes 808, which are located at approximately 1515 nm, 1551 nm, and 1587 nm. Nodes 808 are separated by approximately 36 nm (i.e., the free spectral range of wavelength demultiplexer 318).

Trace 804 comprises a series of nodes 810, separated by approximately 4 nm, which represent the wavelength bands coupled from bus waveguide 706 to bus waveguide 708. The separation between these wavelength bands is approximately 4 nm (i.e., the free spectral range of waveguide resonator 320).

Wavelength demultiplexer 318 and waveguide resonator 320 are controlled such that nulls 806 and nodes 808 are spectrally aligned with nodes 810. As a result, wavelength channels located where nodes 808 and 810 coincide are coupled to bus waveguide 708. Wavelength demultiplexer 318 and/or waveguide resonator 320 are tuned, via control elements 510, to couple any wavelength channel of WDM signal 104 to bus waveguide 708. Bus waveguide 708 is optically coupled to drop waveguide 114 through drop-port 314.

The present invention exploits the fact that a waveguide resonator has a spectral response that is much narrower than the spectral response of an MZ filter. As a result, in the regions where their spectral responses are aligned, waveguide resonator 320 blocks all but a narrow portion of the wavelength range that would be otherwise be passed to drop port 314 by wavelength demultiplexer 318. In other words, the narrower filter response of waveguide resonator 320 dictates the width of the filter response of the combination of wavelength demultiplexer 318 and waveguide resonator 320 such that they collectively block all but a narrow spectral range of WDM signal 104 from reaching drop port 314. It is an aspect of the present invention, therefore, that the spectral response of waveguide resonator narrows the spectral width of wavelength channels coupled to bus waveguide 708.

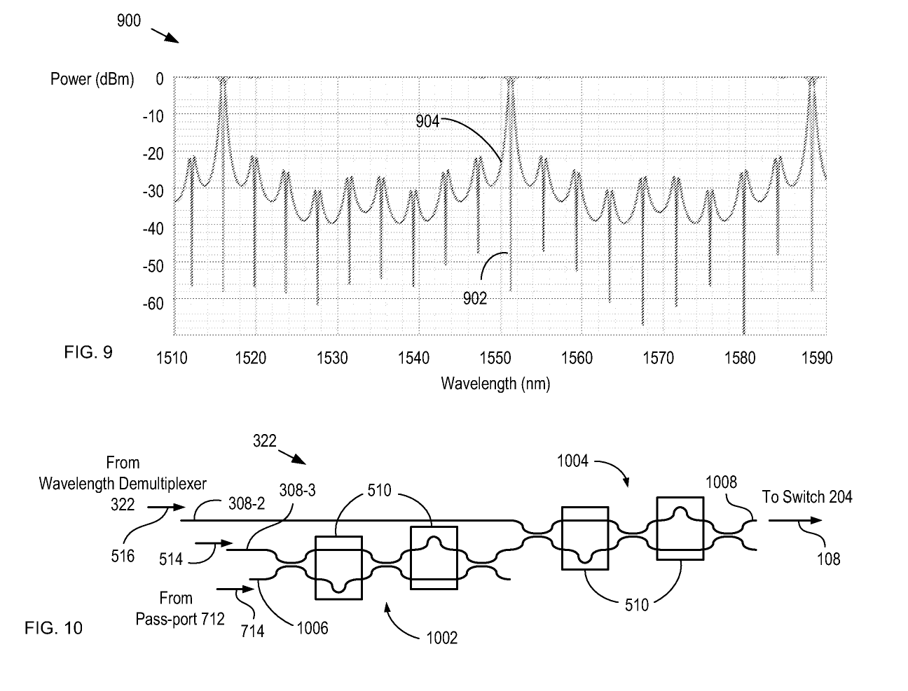

FIG. 9 depicts plots of the optical power passed and dropped by a wavelength filter in accordance with the illustrative embodiment of the present invention. Plot 900 shows the optical power at through-port 312 (trace 902) and the optical power at drop-port 314 (trace 904) in response to input light having a continuous spectral width from 1510 nm to 1590 nm.

Traces 902 and 904 demonstrate the narrow-spectrum behavior of module 100. At each of the wavelengths of 1515 nm, 1551 nm, and 1587 nm, a spectrally narrow band of optical power is transferred from WDM signal 108 to drop signal 112.

At operation 305, add signal 116 is injected into WDM signal 108.

Add signal 116 is provided to waveguide resonator 320 at add-port 316 via add waveguide 118. In order for add signal 116 to couple from bus waveguide 708 to bus waveguide 706, add signal 116 is provided such that it has a wavelength that is at a resonant wavelength of waveguide resonator 320. When this condition is met, add signal 116 can be added to optical signal 714 and conveyed to pass-port 712.

FIG. 10 depicts a schematic drawing of a top view of a circuit layout for a wavelength multiplexer in accordance with the illustrative embodiment of the present invention. Wavelength multiplexer 322 comprises MZ filters 1002 and 1004, input-port 1006, output-port 1008, and control elements 510. The layout and design of wavelength multiplexer 322 is substantially a mirror image of the layout and design of wavelength demultiplexer 318 about line 324. As a result, wavelength demultiplexer 318, waveguide resonator 320, and wavelength multiplexer 322 collectively form a layout that is substantially symmetric about line 324, as described above and with respect to FIG. 3B.

Input-port 1006 receives add signal 116 from pass-port 712. Since the filter response of wavelength multiplexer 322 is substantially identical to that of wavelength demultiplexer 318, when add-signal 116 is characterized by a wavelength at which a node 806 and a node 808 align (e.g., 1550 nm), wavelength multiplexer 322 couples add-signal 116 to output-port 1008. At output-port 1008, optical signals 514 and 516 are combined with add signal 116 to collectively form WDM signal 108.

Output-port 1008 is optically coupled with through-port 312 through switch 304. At switch 304, therefore, WDM signal 108 is coupled to output waveguide 110 via through-port 312.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A wavelength filter, the wavelength filter comprising:
a wavelength demultiplexer comprising first vernier filter comprising a first lattice filter that is a Mach-Zehnder filter and a second lattice filter that is a Mach-Zehnder filter;
a waveguide resonator; and
a wavelength multiplexer comprising a second vernier filter comprising a third lattice filter that is a Mach-Zehnder filter and a fourth lattice filter that is a Mach-Zehnder filter;
wherein the wavelength demultiplexer, the waveguide resonator, and the wavelength multiplexer collectively define a planar lightwave circuit that is substantially symmetric about a line of symmetry through the waveguide resonator, and wherein the planar lightwave circuit is wavelength tunable over a wavelength range.

2. The wavelength filter of claim 1 further comprising a heater that is thermally coupled with the first lattice filter, wherein the response of the first lattice filter is based on the temperature of the heater.

3. The wavelength filter of claim 1 further comprising a region of liquid crystal that is optically coupled with the first lattice filter, wherein the response of the first lattice filter is based on the phase of the region of liquid crystal.

4. The wavelength filter of claim 1 wherein the first lattice filter is characterized by a first free spectral range and the second lattice filter is characterized by a second free spectral range, and wherein the first vernier filter is characterized by a third free spectral range that is based on the first free spectral range and second free spectral range.

5. The wavelength filter 4 wherein the first vernier filter is characterized by a filter response having a plurality of nulls, and wherein the waveguide resonator is characterized by a fourth free spectral range that is substantially equal to the third free spectral range.

6. The wavelength filter of claim 4 wherein the third lattice filter is characterized by the first free spectral range and the fourth lattice filter is characterized by the second free spectral range, and wherein the second vernier filter is characterized by the third free spectral range.

7. The wavelength filter of claim 1 further comprising:
a first switch, wherein the first switch provides a first portion of a first light signal to the planar lightwave circuit, and wherein the first switch controls the first portion within the range of substantially zero percent to substantially 100 percent of the first light signal; and
a second switch, wherein the second switch is optically coupled with the planar lightwave circuit such that the second switch is enabled to receive light from the planar lightwave circuit;
wherein the first switch and second switch are substantially symmetrically arranged about the line of symmetry.

8. The wavelength filter of claim 1 wherein the planar lightwave circuit comprises a waveguide that includes a waveguide core having an inner core of stoichiometric silicon dioxide (SiO₂) and an outer core of stoichiometric silicon nitride (Si₃N₄).

9. The wavelength filter of claim 1 further comprising an optical output port, the optical output port being optically coupled with a bus waveguide included in the waveguide resonator.

10. The wavelength filter of claim 9 further comprising an optical input port, the optical input port being optically coupled with a bus waveguide included in the waveguide resonator.

11. The wavelength filter of claim 1 further comprising:
a heater, wherein the heater is thermally coupled with a first portion of the planar lightwave circuit; and
a controller, wherein the controller provides a plurality of electrical pulses to the heater, and wherein the controller controls the temperature of the heater by controlling the pulse-width of each of the plurality of pulses.

12. A wavelength filter, the waveguide filter comprising:
a first vernier filter comprising a first lattice filter that is a surface-waveguide-based Mach-Zehnder filter and a second lattice filter that is a surface-waveguide-based Mach-Zehnder filter, wherein the first lattice filter is wavelength-tunable;
a second vernier filter comprising a third lattice filter that is a surface-waveguide-based Mach-Zehnder filter and a fourth lattice filter that is a surface-waveguide-based Mach-Zehnder filter, wherein the third lattice filter is wavelength-tunable; and
a waveguide resonator, wherein the first vernier filter and second vernier filter are substantially symmetric about a line of symmetry through the waveguide resonator;
wherein the first vernier filter, second vernier filter, and waveguide resonator are optically coupled.

13. The wavelength filter of claim 9 further comprising:
a first switch comprising an input waveguide, a first bus waveguide, and a second bus waveguide that is optically coupled with the first vernier filter, wherein the first switch is dimensioned and arranged to control the distribution of light from the input waveguide into the first bus waveguide and second bus waveguide; and
a second switch comprising an output waveguide, a third bus waveguide, and a fourth bus waveguide that is optically coupled with the second vernier filter, wherein the second switch is dimensioned and arranged to couple light from each of the third bus waveguide and fourth bus waveguide into the output waveguide.

14. The wavelength filter of claim 9 further comprising:
a first heater, the first heater being thermally coupled with the first lattice filter;
a second heater, the second heater being thermally coupled with the second lattice filter; and
a controller;
wherein the controller controls the temperature of the first heater via a first pulse-width modulated electrical signal, and wherein the controller controls the temperature of the second heater via a second pulse-width modulated electrical signal.

15. The wavelength filter of claim 9 further comprising:
a first region of liquid crystal material, the first region of liquid crystal material being optically coupled with the first lattice filter;
a second region of liquid crystal material, the second region of liquid crystal material being optically coupled with the second lattice filter;
a controller, wherein the controller controls the phase of each of the first region of liquid crystal material and the second region of liquid crystal material, the wavelength response of the first lattice filter being based on the phase of the first region of liquid crystal material, and the wavelength response of the second lattice filter being based on the phase of the second region of liquid crystal material.

16. The wavelength filter of claim 9 wherein each of the first vernier filter, the second vernier filter, and waveguide resonator comprises a waveguide that includes a waveguide core having an inner core of stoichiometric silicon dioxide (SiO₂) and an outer core of stoichiometric silicon nitride (Si₃N₄).

17. A method comprising:
receiving a first light signal at a first vernier filter comprising a first lattice filter that comprises a wavelength-tunable Mach-Zehnder filter, the first light signal being characterized by a first wavelength range;
providing a second light signal from the first vernier filter, the second light signal being a portion of the first light signal characterized by a second wavelength range that is narrower than the first wavelength range;
receiving the second light signal at a waveguide resonator; and
providing a third light signal from the waveguide resonator, the third light signal being a portion of the second light signal characterized by a third wavelength range that is narrower than the second wavelength range.

18. The method of claim 17 further comprising controlling the center wavelength of the second wavelength range, wherein the center wavelength is controlled by operations comprising controlling the wavelength response of the first lattice filter.

19. The method of claim 18 wherein the wavelength response of the first lattice filter is controlled by controlling the temperature of a heater, the heater being thermally coupled with the first lattice filter.

20. The method of claim 19 wherein the temperature of the heater is controlled by controlling the duty factor of a pulse-width modulated electrical signal provided to the heater.

21. The method of claim 18 wherein the first lattice filter is tuned by controlling the phase of a region of liquid crystal, the liquid crystal being optically coupled with the first lattice filter.

22. The method of claim 17 further comprising:
conveying a fourth light signal through the waveguide resonator;
receiving the fourth light signal at a second vernier filter comprising a first lattice filter that comprises a wavelength-tunable Mach-Zehnder filter; and
providing a fifth light signal comprising the fourth light signal at an output port that is optically coupled with the second lattice filter.

23. The method of claim 17 further comprising providing the first light signal from a first switch, wherein the first light signal is a portion of a fourth light signal received by the switch, the portion being within the range of substantially zero percent to substantially 100 percent of the fourth light signal.

24. The method of claim 17 further comprising providing the first vernier filter and the waveguide resonator, wherein each of the first vernier filter and waveguide resonator comprises a waveguide that includes a waveguide core having an inner core of stoichiometric silicon dioxide (SiO₂) and an outer core of stoichiometric silicon nitride (Si₃N₄).

25. The method of claim 24 further comprising providing the first light signal such that the first wavelength range includes wavelengths within the range of approximately 300 nm to approximately 800 nm.

26. The method of claim 24 further comprising providing the first light signal such that the first wavelength range includes wavelengths within the range of approximately 800 nm to approximately 1300 nm.

27. The method of claim 24 further comprising providing the first light signal such that the first wavelength range includes wavelengths within the range of approximately 1300 nm to approximately 1600 nm.
